(19) United States
(12) Patent Application Publication
(10) Pub. No.: US 2026/0131954 A1
(43) Pub. Date: May 14, 2026

(54) PVC-FREE VESSEL CAPS AND METHODS OF MAKING THEREOF

(71) Applicant: Eastman Chemical Company, Kingsport, TN (US)

(72) Inventors: Rui Xie, Pearland, TX (US); Alain Michel Cagnard, Kingsport, TN (US)

(73) Assignee: Eastman Chemical Company, Kingsport, TN (US)

(21) Appl. No.: 19/119,133

(22) PCT Filed: Oct. 5, 2023
(86) PCT No.: PCT/US2023/076081

§ 371 Date: Apr. 8, 2025

Related U.S. Application Data
(60) Provisional application No. 63/415,145, filed on Oct. 11, 2022.

(51) Int. Cl. B65D 53/02; C08G 63/199

(52) U.S. Cl. CPC B65D 53/02; C08G 63/199

(57) ABSTRACT

A vessel cap for use with a vessel adapted to store foods or beverages, the vessel cap comprising a cap body configured for attachment to a neck of a vessel and a gasket attached to the cap body configured for deformation and compression between the cap body and the vessel, wherein the gasket is made of a seal material comprising at least 50 wt. % of a polyurethane elastomer; wherein the polyurethane elastomer is a reaction product of an isocyanate component and a curative component having a hydroxyl number (OH) of greater than 350.

### TECHNICAL FIELD

Embodiments of the present disclosure generally relate to a PVC-free vessel cap and method of making same, and more particularly, relate to a PVC-free vessel cap comprising a gasket formed from a polyurethane elastomer.

### BACKGROUND

Polyvinyl chlorides (PVCs) have been widely used in food packaging applications, and in particular, they have been used as, for example, as seal materials in vessel caps. However, the manufacture, use, and disposal of PVC however pose environmental and human health hazards. In addition, the presence of PVC in packaging poses compatibility issues such that plastic waste containing PVC and other plastic materials cannot be easily recycled. Further, PVC-based materials often require the use of plasticizers, such as epoxidized soybean oil, which may potentially migrate into foods packed in a vessel, thereby contaminating it.

On the other hand, PVC materials offer processing and performance characteristics necessary in vessel caps. Vessel caps are often used with vessels made of glass or plastic for storing food and/or beverages. Depending on the use environment, vessel caps can have varying degrees of properties. For example, in corrosive conditions, the vessel cap must be impervious to the corrosive material, but still resilient enough to form a seal. Where the vessel cap is used as a bottle cap closure and the closure is applied and removed (and/or resealed), it is desirable for the vessel cap to retain its integrity and not shred or tear such that pieces of it contaminate foods or beverages. Further, the vessel cap should not lose its seal integrity through deformation. Depending upon the type of food and/or liquid contents, the filling temperature might be lower or higher than room temperature (e.g., sterilization), thus placing even greater demands on the vessel cap.

Accordingly, there remains a need for a PVC-free vessel cap for use in packaging of foods and beverages that provides similar or improved processing and/or performance properties to a vessel cap made from PVC.

### SUMMARY

Disclosed in embodiments herein are vessel caps. The vessel caps are for use with a vessel adapted to store foods or beverages, the vessel cap comprising a cap body configured for attachment to a neck of a vessel and a gasket attached to the cap body configured for deformation and compression between the cap body and the vessel, wherein the gasket is made of a seal material which comprises at least 50 wt. % of a polyurethane elastomer; wherein the polyurethane elastomer is a reaction product of an isocyanate component and a curative component having a hydroxyl number (OH) of greater than 350.

Further disclosed in embodiments herein are methods for manufacturing a vessel cap, the vessel cap being adapted for use with a vessel that stores foods or beverages. The method comprises: providing a cap body configured for attachment to a neck of a vessel; reacting an isocyanate component and a curative component having a hydroxyl number (OH) of greater than 350 at a temperature of from 60° C. to 240° C. along a cap body to form a polyurethane elastomer gasket, wherein the polyurethane elastomer gasket is positioned on the cap body such that it may be deformed and compressed when the cap body is attached to a vessel, and wherein the polyurethane elastomer gasket and the cap body together form a vessel cap.

In one or more embodiments herein, the vessel cap is a lug screw cap, a Press-on Twist-Off® cap, a hooded lid, a crimp-on or single-use cap, or a metal cap that can be rolled on to the vessel.

In one or more embodiments herein, the seal material is substantially free of components that are liquid at room temperature.

In one or more embodiments herein, the polyurethane elastomer gasket is substantially free of polyvinyl chloride.

In one or more embodiments herein, the seal material has a Shore A hardness of from 50 to 95.

In one or more embodiments herein, the isocyanate component comprises: i. a polyisocyanate that is an aliphatic isocyanate or a cycloaliphatic isocyanate; and ii. an isocyanate reactive component.

In one or more embodiments herein, the polyisocyanate is selected from the group consisting of hexamethylene diisocyanate (“HDI”) and isomers thereof, isophorone diisocyanate (“IPDI”) and isomers thereof, norbornane diisocyanate (“NBDI”) and isomers thereof, tetramethylxylylene diisocyanate (“TMXDI”) and isomers thereof, and xylylene diisocyanate (“XDI”) and isomers thereof, and mixtures thereof.

In one or more embodiments herein, the isocyanate reactive component is selected from the group consisting of polyether polyols, polyester polyols, polycaprolactone polyols, polycarbonate polyols, hydroxyl-terminated polybutadiene polyols, natural oil-based polyols, short chain glycols, and mixtures thereof.

In one or more embodiments herein, the isocyanate reactive component is a polyester polyol comprising: i. an acid component comprising residues of at least one dicarboxyl monomer; and ii. a diol component comprising residues of (i) a 2,2,4,4-tetraalkyl-1,3-cyclobutanediol (TACD); and (ii) at least one diol or polyol other than TACD, wherein the polyester polyol has a hydroxyl functionality of from 2 to 3.

In one or more embodiments herein, the curative component comprises: i. one or more isocyanate reactive compounds; and ii. a catalyst.

In one or more embodiments herein, the one or more isocyanate reactive compounds are hydroxyl-terminated isocyanate reactive compounds or amine-terminated isocyanate reactive compounds.

In one or more embodiments herein, the hydroxyl-terminated isocyanate reactive compounds are selected from the group consisting of polyether polyols, polyester polyols, polycaprolactone polyols, polycarbonate polyols, hydroxyl-terminated polybutadiene polyols, natural oil-based polyols, short chain glycols, and mixtures thereof.

In one or more embodiments herein, the one or more isocyanate reactive compound is 2,2,4,4-tetraalkyl-1,3-cyclobutanediol.

In one or more embodiments herein, the catalyst is selected from the group consisting of amine-based catalysts, tin-based catalysts, zinc-based catalyst, zirconium-based catalysts, bismuth-based catalysts, and mixtures thereof.

Additional features and advantages of the embodiments will be set forth in the detailed description which follows, and in part will be readily apparent to those skilled in the art from that description or recognized by practicing the embodiments described herein. It is to be understood that both the foregoing and the following description describe various embodiments and are intended to provide an overview or framework for understanding the nature and character of the claimed subject matter.

### DETAILED DESCRIPTION

Reference will now be made in detail to embodiments of vessel caps, and methods of manufacturing thereof. The vessel caps may be used in the packaging of foods and/or beverages. For example, vessel caps described herein may be used with metal or plastic vessels adapted to store foods and/or beverages. The vessel caps are selectively couplable to the vessel to create a fluid tight seal between the vessel and the environment. It is noted, however, that this is merely an illustrative implementation of the embodiments disclosed herein. The embodiments are applicable to other technologies that are susceptible to similar problems as those discussed above. For example, the vessel caps described herein may be used in other packaging applications, such as, cosmetics and pharmaceutical, all of which are within the purview of the present embodiments.

In embodiments herein, the vessel cap comprises a cap body and a gasket attached to the cap body. The vessel cap may be a lug screw cap, a Press-on Twist-Off® cap, a hooded lid, a crimp-on or single-use cap, or a metal cap that can be rolled on to the vessel. In some embodiments, the cap body comprises a top panel portion and a skirt portion extending perpendicularly therefrom, wherein the top panel portion and skirt portion define a generally cylindrical interior recess. The top panel portion may typically be circular in shape. In other embodiments, the cap body comprises a top panel portion and a skirt portion extending perpendicularly therefrom, wherein the top panel portion and skirt portion define a generally cylindrical interior recess, and one or more lugs positioned near an edge of a skirt portion. The lugs may extend radially inward from the skirt into the interior recess. Further examples of suitable vessel caps are described in, for example, U.S. Pat. No. 10,450,449 B2, U.S. Pat. No. 10,189,610 B2, and EP 2 509 883 B1, which are incorporated herein by reference. Gaskets described herein are attached to the cap body and are configured for deformation and compression between the cap body and the vessel. In some embodiments, the gasket is mounted within an interior recess of the cap body to the top panel portion and/or skirt portion.

The gasket is made of a seal material comprising at least 50 wt. % of a polyurethane elastomer. All individual values and subranges are included and disclosed herein. For example, in some embodiments, the polyurethane elastomer comprises at least 60 wt. %, at least 70 wt. %, at least 80 wt. %, at least 90 wt. %, at least 95 wt. % of the seal material. In other embodiments, the polyurethane elastomer comprises from 50 wt. % to 100 wt. %, 65 wt. % to 100 wt. %, 75 wt. % to 100 wt. %, 85 wt. % to 100 wt. %, 92 wt. % to 100 wt. %, or 95 wt. % to 100 wt. % of the seal material.

In embodiments herein, the seal material is substantially free (or alternatively, free) of polyvinyl chloride. As used herein, the term “substantially free” means that no polyvinyl chloride is intentionally added to the seal material. As used herein, the term “free” means that the amount of polyvinyl chloride is undetectable. In one or more embodiments herein, the seal material may be substantially free of components that are liquid at room temperature.

In one or more embodiments herein, the seal material may have a Shore A hardness of from 50 to 95. All individual values and subranges are included and disclosed herein. For example, in some embodiments, the seal material may have a Shore A hardness ranging from a lower limit of 50, 55, 60, 63, or 65 to an upper limit of 95, 90, 85, 83, or 80. The Shore A hardness may be measure according to ASTM D-2240 using a Shore A durometer gauge at 25° C.

In embodiments herein, the polyurethane elastomer is a reaction product of an isocyanate component and a curative component having a hydroxyl number (OH) of greater than 350. In one or more embodiments herein, the isocyanate component may have an NCO content of from 5.0% to 25.0%. All individual values and subranges are included and disclosed herein. For example, in some embodiments, the isocyanate component may have an NCO content ranging from a lower limit of 5.0%, 7.0%, 10.0%, or 11.5% to an upper limit of 25.0%, 20.0%, 18.0%, 15.0%, or 14.5%. The NCO content may be determined according to ASTM D2572.

In some embodiments, the isocyanate component may comprise a polyisocyanate that is an aliphatic isocyanate or a cycloaliphatic isocyanate, and an isocyanate reactive component. As used herein, a “polyisocyanate” is any compound that contains two or more isocyanate groups. Examples of suitable aliphatic polyisocyanates may include aliphatic polyisocyanates that have 3 to 16 carbon atoms, or alternatively, 4 to 12 carbon atoms, in the linear or branched alkylene residue. Examples of suitable cycloaliphatic polyisocyanates may include cycloaliphatic polyisocyanates that have 4 to 18 carbon atoms, or alternatively, 6 to 15 carbon atoms, in the cycloalkylene residue. Further examples of suitable aliphatic and cycloaliphatic polyisocyanates include, but are not limited to, cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate and dodecane di- and triisocyanate, isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), xylylene diisocyanate (XDI), tetramethylxylylene diisocyanate, and dimers, trimers, and mixtures thereof. In one or more embodiments herein, the isocyanate component comprises a polyisocyanate selected from the group consisting of hexamethylene diisocyanate (“HDI”) and isomers thereof, isophorone diisocyanate (“IPDI”) and isomers thereof, norbornane diisocyanate (“NBDI”) and isomers thereof, tetramethylxylylene diisocyanate (“TMXDI”) and isomers thereof, and xylylene diisocyanate (“XDI”) and isomers thereof, and mixtures thereof.

In some embodiments, the isocyanate reactive component may be a polyether polyol, polyester polyol, polycaprolactone polyol, polycarbonate polyol, hydroxyl-terminated polybutadiene polyol, natural oil-based polyol, short chain glycol, or combinations thereof.

Examples of suitable polyether polyols may include but are not limited to, polyethylene glycol, polypropylene glycol, polytetramethylene ether glycols, polybutylene oxide-based polyols, and mixtures thereof. Exemplary polyether polyols may include VORANOL™ polyols available from The Dow Chemical Company (Midland, MI), PLURACOL™ polyols available from BASF SE (Ludwigshafen, Germany), POLY-G™, POLY-L™, and POLY-Q™ polyols available from Lonza Group AG (Basel, Switzerland), and ACCLAIM™ polyols available from Covestro AG (Leverkusen, Germany). Suitable polytetramethylene ether glycols for use may include POLYTHF™ glycols available from BASF SE (Ludwigshafen, Germany), TERATHANE™ glycols available from Invista Company (Wichita, KS), PTMG™ glycols available from Mitsubishi Chemical Corporation (Tokyo, Japan), and PTG™ glycols from Dairen Chemical Corp. (Taipei City, Taiwan). Suitable polybutylene oxide-based polyols may include, but are not limited to, a polybutylene oxide homopolymer polyol, a polybutylene oxide-polypropylene oxide copolymer polyol, and a polybutylene oxide-polyethylene oxide copolymer polyol.

Examples of suitable polyester polyols may include, but are not limited to, aliphatic polyester polyols, aromatic polyester polyols, or copolymers of aliphatic and aromatic polyester polyol, such as STEPANPOL™ polyols available from Stepan Company (Northfield, IL USA), FOMREZ™ polyols available from Chemtura Corporation (Middleburt, CT USA)), POLYOL™ polyols available from Kuraray Co., Ltd (Tokyo, JP), DYNACOLL™ polyols available from Evonik Industries AG (Essen, Germany), and DESMODUR™ available from Covestro AG (Leverkusen, Germany).

In some embodiments, the isocyanate reactive component may be a polyester polyol comprising: (a) an acid component comprising residues of at least one dicarboxyl monomer; and (b) a diol component comprising residues of (i) a 2,2,4,4-tetraalkyl-1,3-cyclobutanediol (TACD); and (ii) at least one diol or polyol other than TACD, wherein the polyester polyol has a hydroxyl functionality of from 2 to 3. Examples of TACDs include 2,2,4,4-tetramethylcyclobutane-1,3-diol (TMCD), 2,2,4,4-tetraethylcyclobutane-1,3-diol, 2,2,4,4-tetra-n-propylcyclobutane-1,3-diol, 2,2,4,4-tetra-n-butylcyclobutane-1,3-diol, 2,2,4,4-tetra-n-pentylcyclobutane-1,3-diol, 2,2,4,4-tetra-n-hexylcyclobutane-1,3-diol, 2,2,4,4-tetra-n-heptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane-1,3-diol, 2,4-dimethyl-2,4-diethyl-cyclobutane-1,3-diol, 2,4-dimethyl-2,4-di-n-propylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol. In some embodiments, TACD may comprise or be TMCD. Examples of suitable diols or polyols other than TACD may include 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, 1-3-propylene glycol, 1-4-propylene glycol, diethylene glycol, dipropylene glycol, triethylene glycol, tetraethylene glycol, polyethylene glycol, pentanediol, dodecandiol, and 2,2-bis(hydroxymethyl) propionic acid (dimethylolpropionic acid).

Examples of suitable polycaprolactone polyols may include, but are not limited to, CAPA™ polyols available from Ingevity Corporation (North Charleston SC USA), PLACCEL™ polycaprolactone polyols available from DAICEL ChemTech, Inc. (Fort Lee, NJ USA), POLYCAP™ available from Connect Chemicals USA, LLC (Alpharetta, GA USA), and CAPROMER™ available from BASF SE (Ludwigshafen, Germany).

Examples of suitable polycarbonate polyols may include but are not limited to PLACCEL™ polycarbonate polyols available from DAICEL ChemTech, Inc. (Fort Lee, NJ USA), ETERNACOLL™ polycarbonate polyols available from UBE Corp. (Tokyo, JP), CONVERGE™ Polyol® available from Saudi Aramco (Dhahran, Saudi Arabia), and DESMOPHEN™ and CARDYON™ polyols available from Covestro AG (Leverkusen, Germany).

Examples of suitable hydroxyl-terminated polybutadiene polyols may include but are not limited to KRASOL™ hydroxyl terminated polybutadiene polyols available from Cray Valley USA, LLC (PA USA), POLY BD™ hydroxyl terminated polyols available from Cray Valley USA, LLC (PA USA), and POLYVEST HT™ liquid polybutadiene polyols available from Evonik Industries AG (Essen, Germany).

Examples of suitable natural oil-based polyols may include but are not limited to SOVERMOL™ available from BASF SE (Ludwigshafen, Germany), STEPANPOL™ available from Stepan Company (Northfield, IL USA), EMEROX™ polyols available from Emery Oleochemicals LLC (Cincinnati, OH USA), BIOH™ polyol available from Cargill, Inc. (Wayzata, MN USA), and POLYCIN™ polyol available from Vertellus Chemicals Company (Indianapolis, IN USA).

Examples of suitable short chain glycols may include, but are not limited to, ethylene glycol, propylene glycol, 1,3-propanediol, 1,4-butanediol, 1,5-pentanediol, 3-methyl-1,5-pentanediol, 1,6-hexanediol, neopentylglycol, methylpentanediol, dimethylbutanediol, butylethylpropanediol, diethylene glycol, triethylene glycol, tetraethylene glycol, dipropylene glycol, tripropylene glycol, bishydroxyethoxybenzene, 1,4-cyclohexanediol, 1,4-cyclohexanedimethanol, 2,2,4,4-tetramethyl-1,3-cyclobutanediol (TMCD), and triethylene glycol.

As previously mentioned herein, the curative component may have a hydroxyl number (OH) of greater than 350. All individual values and subranges are included and disclosed herein. For example, in some embodiments, the curative component may have a hydroxyl number (OH) of ranging from a lower limit of greater than 350, 355, 360, or 365 to an upper limit of 1900, 1850, 1825, or 1815. Hydroxyl number (OH) of the curative component may be measured according to ASTM D4274

In one or more embodiments herein, the NCO to OH ratio may range from 0.95 to 1.5. All individual values and subranges are included and disclosed herein. For example, in some embodiments, the NCO to OH ratio may range from a lower value of 0.950, 1.0, or 1.02 to an upper value of 1.5, 1.3, 1.1, or 1.05. The ratio may be calculated based on the NCO content of the isocyanate component and hydroxyl number of the curative component. The calculation is also shown in ASI Adhesives & Sealants Industry Magazine, Vol. 25, 5, pg. Issue 37 (May 2018) https://digital.bnpmedia.com/publication/?i=491395&article_id=3068591&view=artic leBrowser, which is incorporated herein by reference.

In one or more embodiments herein, the curative component may comprise: (1) one or more isocyanate reactive compounds; and (2) a catalyst. Examples of suitable isocyanate reactive compounds may include hydroxyl-terminated isocyanate reactive compounds or amine-terminated isocyanate reactive compounds. Hydroxyl-terminated isocyanate reactive compounds may include polyether polyols, polyester polyols, polycaprolactone polyols, polycarbonate polyols, hydroxyl-terminated polybutadiene polyols, natural oil-based polyols, short chain glycols, and mixtures thereof. Examples of specific hydroxyl-terminated isocyanate reactive compounds are previously described herein. Amine-terminate isocyanate reactive compounds may include but are not limited to JEFFAMINE™ compounds available from Huntsman Corporation (The Woodlands, TX), VERSALINK™ compounds available from Evonik Industries AG (Essen, Germany), and BAXXODUR™ compounds available from BASF SE (Ludwigshafen, Germany). In some embodiments, the one or more isocyanate reactive compound is 2,2,4,4-tetraalkyl-1,3-cyclobutanediol (TACD) as previously described herein.

The catalyst may be an amine-based catalysts, tin-based catalysts, zinc-based catalyst, zirconium-based catalysts, bismuth-based catalysts, or mixtures thereof, as is known in the art. Examples of suitable catalysts may include, but are not limited to, triethylenediamine, N-methyl morpholine, N-ethyl morpholine, diethyl ethanolamine, N-coco morpholine, 1-methyl-4-dimethylaminoethyl piperazine, 3-methoxy-N-dimethylpropylamine, N,N-diethyl-3-diethylaminopropylamine, dimethylbenzyl amine, dimethyltindilaurate, dibutyltindilaurate, stannous octoate, zinc naphthenate, zinc neodecanoate, zinc versalate, bismuth neodecanoate, bismuth versalate, tetrabenzyl zirconium, zirconium tetra-t-butoxide, zirconium tetraisopropoxide, tetra(dimethylamido) zirconium, or zirconium diisopropoxide bis(2,2,6,6-tetramethyl-3,5-heptanedionate), and mixtures thereof.

Also disclosed in embodiments described herein are methods of manufacturing a vessel cap, the being adapted for use with a vessel that stores foods or beverages as previously described herein. The method comprises providing a cap body configured for attachment to a neck of a vessel; reacting an isocyanate component and a curative component having a hydroxyl number (OH) of greater than 350 at a temperature of from 60° C. to 240° C. (alternatively, 60° C. to 140° C.) along a cap body to form a polyurethane elastomer gasket, wherein the polyurethane elastomer gasket is positioned on the cap body such that it may be deformed and compressed when the cap body is attached to a vessel, and wherein the polyurethane elastomer gasket and the cap body together form a vessel cap. The cap body may be attached to a neck of a vessel by a variety of ways (e.g., screw, adhesive, etc.) known to those skilled in the art.

### Test Methods

### Gel Point

Gel point of a polyurethane elastomer composition is defined as the time it takes for the composition to be tack free at 120° C. after the isocyanate component is mixed with the curative component. The gel point is reported in seconds.

### Tensile Strength

Tensile strength is measured according to ASTM D412 on an MTS Criterion Model 46 using a 100 Newton load cell. The tensile strength is reported in megapascals (MPa).

### Elongation at Break

Elongation at Break is measured according to ASTM D412 on an MTS Criterion Model 46 using a 100 Newton load cell. The elongation at break is reported in percent (%).

### Shore A Hardness

Shore A hardness is measure at 25° C. according to ASTM D-2240 using a Shore A gauge from Rex Gauge Company.

### NCO Content

The NCO content of the isocyanate component is measured according to ASTM D2572. The NCO content is reported in percent (%).

### Hydroxyl (OH) Number

Hydroxyl number (OH) of the curative component is measured according to ASTM D4274.

### Acid Number

Acid number is measured according to ASTM D664.

### EXAMPLES

The following specific examples are given to illustrate the process and performance properties associated with PVC-free seal material, which would be used in vessel caps.

TABLE 1
Raw Materials

| | |
|---|---|
| Material/Name | Description |

Polyols

| | |
|---|---|
| ETERNACOLL ™ PH-50 | 500 Mw polycarbonate diol available from UBE Corp. (Tokyo, JP). |
| ETERNACOLL ™ PH-100 | 1000 Mw polycarbonate diol available from UBE Corp. (Tokyo, |
| | JP). |
| DESMOPHEN ™ C 2202 | 2000 Mw polycarbonate diol available from Covestro AG |
| | (Leverkusen, Germany). |
| STEPANOL ™ PC-1011P-210 | 540 Mw polyester polyol available from Stepan Company |
| | (Northfield, IL). |
| STEPANOL ™ PC-1011-55 | 2000 Mw polyester polyol available from Stepan Company |
| | (Northfield, IL). |
| KURARAY POLYOL ™ P- | 500 Mw polyester polyol available from Kuraray Co., Ltd (Tokyo, |
| 510 | JP). |
| KURARAY POLYOL ™ | 2000 Mw polyester polyol available from Kuraray Co., Ltd (Tokyo, |
| P2010 | JP). |
| PTMEG 650 | 650 Mw polyether polyol based on polytetrmethylene ether glycol |
| | available from Gantrade Corp. (Montvale, NJ). |
| Polyester Polyol A | a polyester polyol based on TACD produced as described below. |
| 1,4 Butanediol | available from Sigma-Aldrich (St. Louis, MO). |
| 1,3 Butanediol | available from Sigma-Aldrich (St. Louis, MO). |
| Adipic Acid | available from Sigma-Aldrich (St. Louis, MO). |
| 1,4-cyclohexanedimethanol | available from Eastman Chemical Company (Kingsport, TN). |
| 2,2,4,4-tetramethyl-1,3- | available from Eastman Chemical Company (Kingsport, TN) |
| cyclobutanediol | |
| 1,5-pentanediol | available from Sigma-Aldrich (St. Louis, MO). |
| 3-methyl-1,5-pentanediol | available from Sigma-Aldrich (St. Louis, MO). |

Polyisocyanates

| | |
|---|---|
| DESMODUR ™ H | hexamethylene diisocyanate available from Covestro AG |
| | (Leverkusen, Germany). |
| DESMODUR ™ N3300 | polymeric isocyanate based on hexamethylene diisocyanate. |
| | available from Covestro AG (Leverkusen, Germany). |
| TAKENATE ™ 500 | m-xylene diisocyanate available from Mitsui Chemicals, Inc. |
| | (Tokyo, JP). |

Catalyst

| | |
|---|---|
| K-KAT ™ XK-672 | Mixture of zinc and zirconium mixed carboxylate catalyst available |
| | from King Industries, Inc. (Norwalk, CT). |

PVC

| | |
|---|---|
| VESTOLIT G 178 | high molecular weight PVC resin available from Mexichem |
| | Specialty Resins Inc. (Avon Lake, OH). |

Additives

| | |
|---|---|
| DRAPEX ™ 6.8 | epoxidized soybean oil plasticizer supplied by Galata Chemicals |
| | LLC (Jersey City, NJ). |
| IRGAFOS ™ 168 | tris(2,4-di-tert.-butylphenyl) phosphite antioxidant available from |
| | BASF SE (Ludwigshafen, Germany). |
| WESTON ™ 618F | phosphite antioxidant available from SI Group (The Woodlands, |
| | TX) |

Polyester Polyol A is prepared as follows: in a four-neck 5-liter glass reactor equipped with a mechanical stirrer, a thermocouple, a heated partial condenser (100° C.), a Dean-Stark trap, a chilled condenser (15° C.), and a nitrogen inlet, 1753.2 grams of adipic acid, 1040.6 grams of 1,5-pentanediol, 411.8 grams of 1,4-cyclohexanedimethanol, 205.9 grams of 2,2,4,4-tetramethyl-1,3-cyclobutanediol, 3.41 grams of IRGAFOS™ 168, and 3.41 grams of WESTON™ 618F are charged. The reactor is placed in a heating mantle connected to a temperature controller. With nitrogen on, the mixture in the reactor is slowly heated up to 110° C. Once the mixture is melted, agitation is applied at 200 rpm. With agitation on under nitrogen sweep, the mixture is heated to 230° C. at a ramp speed of 0.2° C./minute. The mixture is allowed to react further under a nitrogen blanket at 230° C. A sample is taken after 6 hours at 230° C. for acid number analysis. If the acid number is more than 1.0 mg KOH/g, the reaction will be allowed to continue until the acid number of the reaction mixture reaches less than or equal to 1.0 mg KOH/g. The resultant material is a clear liquid at room temperature.

Comparative Example A is prepared by adding into a dry 200 Max FlackTek cup, 100 grams of VESTOLIT G 178 and 73 grams of DRAPEX™ 6.8. The cup is then placed in a FlackTek DAC 1200-500 VAC and mixed at 2000 rpm for 5 minutes followed by mixing at 2000 rpm for an additional 5 minutes under vacuum. A homogenous, viscous, off-white dispersion is obtained. The mixture is then poured into an aluminum mold preconditioned at 190° C. to form a sample sheet at about 1.9 mm thickness and the gel point is determined. After curing at 190° C. for 1 hour, the specimen is removed from the mold and conditioned at an ambient environment for two weeks before it is subjected to testing of physical properties. Shore A hardness, tensile strength, and elongation at break are measured and the results are provided in Table 3.

The exemplary formulations are prepared as follows:

### Inventive Example 1

Isocyanate Component: A 500 ml lab glass reactor consisting of a 4-neck flask equipped with a mechanical stir and a temperature controller is used to produce the isocyanate component. Under nitrogen blanket, into the lab glass reactor, 81.8 grams of DESMODUR™ H is first loaded. The temperature of the reactor is set to 50° C. With agitation on, 100.0 grams of POLYOL™ P-510 polyol preheated to 60° C. is added to the reactor. Cooling is applied if the reaction temperature exceeds 95° C. Reset the temperature of the reactor to 95° C. after exotherm of the reaction is leveled off. The reaction is held at 95° C. for 5 hours followed by addition of 32.1 grams of DESMODUR™ N3300. After mixing for additional 45 minutes at 95° C., a clear, low viscosity prepolymer is obtained. The prepolymer is found to have an NCO content of 14.3%.

Curative Component: A 500 ml lab glass reactor consisting of a 4-neck flask equipped with a mechanical stir and a temperature controller is used to produce the isocyanate reactive component. The temperature of the reactor is set at 65° C. Under N2 purge and with agitation on, 170.0 grams of POLYOL™ P-510 polyol preheated to 60° C. is charged to the reactor, followed by the addition of 30.0 grams of 1,4 butanediol, and 2.0 grams of K-KAT XK-672. After mixing at 60° C. for 45 minutes, a clear, low viscosity liquid is obtained. The mixture has an OH number of 377.5.

Polyurethane Elastomer: Into a dry 200 Max FlackTek cup, 50.0 grams of the curative component preheated at 65° C. and 101.7 grams of the isocyanate component preheated at 65° C. are added. Mixing is done on a FlackTek DAC 1200-500 VAC at 2000 rpm under vacuum for 1 minutes. The mixture is then poured into an aluminum mold preconditioned at 120° C. to form a sample sheet at about 1.9 mm thickness and determine the gel point. After cured at 120° C. for 1 hour, the specimen is removed from the mold and conditioned at an ambient environment for two weeks before it is subjected to physical property testing. Results are listed in Table 2.

### Inventive Example 2

Isocyanate Component: Example 1 is repeated except that 77.9 grams of DESMODUR™ H, 100.0 grams of PH-50, and 31.4 grams of DESMODUR™ N3300 are used. The prepolymer is a clear, low viscosity liquid at room temperature and has an NCO content of 13.9%.

Curative Component: Example 1 is repeated except that 170.0 grams of PH-50, 30.0 grams of 1,4 butanediol, and 2.0 grams of K-KAT XK-672 are used. The mixture is a clear, viscous liquid at room temperature and has an OH number of 371.5.

Polyurethane Elastomer: Example 1 is repeated except that 103.8 grams of the isocyanate component and 50.0 grams of the curative component are used. Results are listed in Table 2.

### Inventive Example 3

Isocyanate Component: Example 1 is repeated except that 126.4 grams of TAKENATE™ 500, 75.0 grams of POLYOL™ P-510, 25.0 grams of 3-methyl 1,5 pentanediol, and 25.2 grams of DESMODUR™ N3300 are used. The prepolymer is a clear, low viscosity liquid at room temperature and has an NCO content of 12.5%.

Curative Component: Example 1 is repeated except that 85.0 grams of POLYOL™ P-510, 15.0 grams of 1,4 butanediol, and 1.0 grams of K-KAT XK-672 are used. The mixture is a clear, viscous liquid at room temperature and has an OH number of 377.4.

Polyurethane Elastomer: Example 1 is repeated except that 116.7 grams of the isocyanate component and 50.0 grams of the curative component are used. Results are listed in Table 2.

### Inventive Example 4

Isocyanate Component: Example 1 is repeated except that 111.1 grams of TAKENATE™ 500, 75.0 grams of PTMEG 650, 25.0 grams of 3-methyl 1,5 pentanediol, and 37.3 grams of DESMODUR™ N3300 are used. The prepolymer is a clear, low viscosity liquid at room temperature and has an NCO content of 12.1%.

Curative Component: Example 1 is repeated except that 80.0 grams of PTMEG 650, 20.0 grams of 1,4 butanediol, and 1.0 grams of K-KAT XK-672 are used. The mixture is a clear, viscous liquid at room temperature and has an OH number of 387.8.

Polyurethane Elastomer: Example 1 is repeated except that 123.5 grams of the isocyanate component and 50.0 grams of the curative component are used. Results are listed in Table 2.

### Inventive Example 5

Isocyanate Component: Example 1 is repeated except that 88.7 grams of DESMODUR™ H, 80.0 grams of POLYOL™ P2010, 20.0 grams of 1,3 butanediol, and 21.0 grams of DESMODUR™ N3300 are used. The prepolymer is a clear, low viscosity liquid at room temperature and has an NCO content of 12.6%.

Curative Component: Example 1 is repeated except that 69.0 grams of POLYOL™ P-510, 11.0 grams of 1,4 butanediol, and 0.8 grams of K-KAT XK-672 are used. The mixture is a clear, viscous liquid at room temperature and has an OH number of 364.6.

Polyurethane Elastomer: Example 1 is repeated except that 91.0 grams of the isocyanate component and 40.0 grams of the curative component are used. Results are listed in Table 2.

### Inventive Example 6

Isocyanate Component: Example 1 is repeated except that 182.8 grams of DESMODUR™ H, 160.0 grams of Polyester Polyol A, 40.0 grams of 1,3 butanediol, and 42.6 grams of DESMODUR™ N3300 are used. The prepolymer is a clear, low viscosity liquid at room temperature and has an NCO content of 12.8%.

Curative Component: Example 1 is repeated except that 60.0 grams of Polyester Polyol A, 20.0 grams of 1,4 butanediol, and 0.8 grams of K-KAT XK-672 are used. The mixture is a clear, viscous liquid at room temperature and has an OH number of 361.2.

Polyurethane Elastomer: Example 1 is repeated except that 97.7 grams of the isocyanate component and 40.0 grams of the curative component are used. Results are listed in Table 2.

TABLE 2
Results

| | Processing | Gel | | Tensile | Elongation | |
|---|---|---|---|---|---|---|
| | Temperature | Point, | Hardness, | Strength, | @ Break, | NCO/OH |
| | Window, ° C. | seconds | Shore A | MPa | % | Ratio |
| Example 1 | 60-140 | 120 | 60 | 9.7 | 410 | 1.02 |
| Example 2 | 60-140 | 100 | 70 | 30.5 | 427 | 1.02 |
| Example 3 | 60-140 | 120 | 55 | 7.4 | 635 | 1.03 |
| Example 4 | 60-140 | 110 | 55 | 7.9 | 431 | 1.03 |
| Example 5 | 60-140 | 120 | 60 | 14.3 | 509 | 1.03 |
| Example 6 | 60-140 | 100 | 82 | 30.1 | 514 | 1.03 |
| Comparative | 190-220 | 120 | 61 | 6 | 207 | — |
| Example A | | | | | | |

As shown in the Tables above, the formulations of the present invention exhibit lower processing temperatures and, at the same time, the mechanical properties of the formulations are either not compromised or significantly improved.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A vessel cap for use with a vessel adapted to store foods or beverages, the vessel cap comprising a cap body configured for attachment to a neck of a vessel and a gasket attached to the cap body configured for deformation and compression between the cap body and the vessel, wherein the gasket is made of a seal material comprising at least 50 wt. % of a polyurethane elastomer; wherein the polyurethane elastomer is a reaction product of an isocyanate component and a curative component having a hydroxyl number (OH) of greater than 350.

2. The vessel cap of claim 1, wherein the vessel cap is a lug screw cap, a Press-on Twist-Off® cap, a hooded lid, a crimp-on or single-use cap, or a metal cap that can be rolled on to the vessel.

3. The vessel cap of claim 1, wherein the seal material is substantially free of components that are liquid at room temperature.

4. The vessel cap of claim 1, polyurethane elastomer gasket is substantially free of polyvinyl chloride.

5. The vessel cap of claim 1, wherein the seal material has a Shore A hardness of from 50 to 95.

6. The vessel cap of claim 1, wherein the isocyanate component comprises:
i. a polyisocyanate that is an aliphatic isocyanate or a cycloaliphatic isocyanate; and
ii. an isocyanate reactive component.

7. The vessel cap of claim 6, wherein the polyisocyanate is selected from the group consisting of hexamethylene diisocyanate (“HDI”) and isomers thereof, isophorone diisocyanate (“IPDI”) and isomers thereof, norbornane diisocyanate (“NBDI”) and isomers thereof, tetramethylxylylene diisocyanate (“TMXDI”) and isomers thereof, and xylylene diisocyanate (“XDI”) and isomers thereof, and mixtures thereof.

8. The vessel cap of claim 6, wherein the isocyanate reactive component is selected from the group consisting of polyether polyols, polyester polyols, polycaprolactone polyols, polycarbonate polyols, hydroxyl-terminated polybutadiene polyols, natural oil-based polyols, short chain glycols, and mixtures thereof.

9. The vessel cap of claim 6, wherein the isocyanate reactive component is a polyester polyol comprising:
i. an acid component comprising residues of at least one dicarboxyl monomer; and
ii. a diol component comprising residues of
(i) a 2,2,4,4-tetraalkyl-1,3-cyclobutanediol (TACD); and
(ii) at least one diol or polyol other than TACD,
wherein the polyester polyol has a hydroxyl functionality of from 2 to 3.

10. The vessel cap of claim 1, wherein the curative component comprises:
i. one or more isocyanate reactive compounds; and
ii. a catalyst.

11. The vessel cap of claim 10, wherein the one or more isocyanate reactive compounds are hydroxyl-terminated isocyanate reactive compounds or amine-terminated isocyanate reactive compounds.

12. The vessel cap of claim 11, wherein the hydroxyl-terminated isocyanate reactive compounds are selected from the group consisting of polyether polyols, polyester polyols, polycaprolactone polyols, polycarbonate polyols, hydroxyl-terminated polybutadiene polyols, natural oil-based polyols, short chain glycols, and mixtures thereof.

13. The vessel cap of claim 10, wherein the one or more isocyanate reactive compound is 2,2,4,4-tetraalkyl-1,3-cyclobutanediol.

14. The vessel cap of claim 10, wherein the catalyst is selected from the group consisting of amine-based catalysts, tin-based catalysts, zinc-based catalyst, zirconium-based catalysts, bismuth-based catalysts, and mixtures thereof.

15. A method for manufacturing the vessel cap of claim 1, the vessel cap being adapted for use with a vessel that stores foods or beverages, the method comprising:
providing a cap body configured for attachment to a neck of a vessel;
reacting an isocyanate component and a curative component having a hydroxyl number (OH) of greater than 350 at a temperature of from 60° C. to 240° C. along a cap body to form a polyurethane elastomer gasket, wherein the polyurethane elastomer gasket is positioned on the cap body such that it may be deformed and compressed when the cap body is attached to a vessel, and wherein the polyurethane elastomer gasket and the cap body together form a vessel cap.
